(19) United States
(12) Patent Application Publication
(10) Pub. No.: US 2002/0083126 A1
(43) Pub. Date: Jun. 27, 2002

(54) Online election system

(76) Inventors: Robert Angus Best, Castle Hill (AU); Alan William James Conder, Queenscliffe (AU)

Correspondence Address: David P. Gordon, Esq., 65 Woods End Road, Stamford, CT, 06905, US

(21) Appl. No.: 09/974,111

(22) Filed: Oct. 9, 2001

Related U.S. Application Data
(63) Continuation-in-part of application No. PCT/AU00/00307, filed on Apr. 12, 2000.

(30) Foreign Application Priority Data
Apr. 12, 1999 (AU) PP 9714

(51) Int. Cl. G06F 15/16

(52) U.S. Cl. 709/203

(57) ABSTRACT

An online election system has a database of registered votes. A voter accessing the election system through a server means end user interface verifies themselves by providing security information such as a unique identifier and password. The voter is then presented with a list of candidates and is prompted to indicate their vote which is then submitted to the sever. Confidentiality of a vote is ensured because all voter identification is removed from the vote when the vote is received at the server means and before the vote is stored and tallied. The privacy of the vote is further enhanced by encrypting communications between the server means and the user interface.

This application is a continuation-in-part application based on PCT application No. PCT/AU00/00307 the international filing date of which is Apr. 12, 2000.

### BACKGROUND OF THE INVENTION

This invention relates to a system for voting, particularly for conducting an election, using a computer network.

Elections are used to select representatives in many situations for example members of parliament or congress, local council members and members of a board of directors Elections can however place a large burden on resources, financial, human, time etc, and can be inconvenient to the electorate if voters have to disrupt their normal routines or go out of their way to participate In elections where voting is not compulsory, this inconvenience can lead to voter apathy and low voter participation rates. The present invention seeks to provide a system for conducting an election at greater convenience to voters and at lower cost to administrators

In addition to its suitability for elections, the invention will be applicable to other voting procedures, for example, referenda and plebiscites

### SUMMARY OF THE INVENTION

The invention broadly resides in a voting system including a computer network laving server means and a plurality of user interfaces, said system ether including.

a) a registered voter database accessible by said server means and containing voter identification records for a plurality of registered voters;

b) a voter verification system including means to receive identification information provided by a user at a user interface and means to determine if said user is a registered voter by matching said information provided by said user to a record contained in said registered voter database;

c) means to display ballot information at a user interface;

d) means by which a registered voter can indicate their vote at the user interface;

e) means by which a registered voter can submit their vote from the user interface to the server means;

f) means for tallying votes submitted by a plurality of registered voters;

g) wherein when a vote is received at the server means

i) all voter identification is removed from the vote,

ii) the vote is passed to the means for tallying and

iii) the registered voter who submitted the vote is flagged as having voted.

In a preferred form the invention resides in an online voting system including

a) a computer network having a Voter Server, a Voting Server and a plurality of user interfaces, said system further including

b) a registered voter database accessible by said Voter Server and containing voter identification records for a plurality of registered voters;

c) a voter verification system including said Voter Server; said system including

i) means to receive personal identification information provided by a user at a user interface and

ii) means to determine if said user is a registered voter by matching said personal information provided by said user to a record contained in said registered voter database;

d) means associated with said Voting Server to display at a user interface election information including a list of election candidates;

e) means by which a registered voter can indicate their vote at the user interface;

f) means by which a registered voter can submit their vote from the user interface to the Voting Server;

g) means for tallying a plurality of votes submitted by a plurality of registered voters;

h) wherein when a vote is received at the Voting Server all voter identification is removed from the vote, the vote is passed to the means for tallying and the registered voter who submitted the vote is flagged in said registered voter database as having voted

The functions of the Voter Server and the Voting Server may be carried out by one server, referred to herein as a host server Where this is the case, the invention may reside in an online election system including a computer network having a host saver and a plurality of user interface, said system firer including:a

registered voter database accessible by said host server and containing voter identification records for a plurality of registered voters;

a voter verification system including means to receive personal identification information provided by a user at a user interface and means to determine if said user is a registered voter by matching said personal information provided by said user to a record contained in said registered voter database;

means to display at a user interface election information including a list of election candidates

means by which a registered voter can indicate their vote at the use interface;

means by which a registered voter can submit their vote from the user interface to the host server;

means to prevent a registered voter from submitting more than one vote;

means for tallying a plurality of votes submitted by a plurality of registered voters;

wherein when a vote is received at the host server all voter identification is removed from the vote, the vote is passed to the means for tallying and the registered voter who submitted the vote is flagged as having voted.

Preferably, however, the functions of Voting Server and Voter Server are provided by separate servers on the network, with appropriate secure communication protocols.

Preferably communications between the servers and the user interfaces are encrypted.

Preferably the list of candidates displayed at a user interface is determined from one or more details contained in a registered voter's record,

### BRIEF DESCRIPTION OF THE DRAWINGS

The invention will now be described by way of preferred embodiments intended as non-limiting examples only, and with reference to the accompanying drawings, in which:

FIG. 1 shows a schematic view of a system according to a first embodiment of the invention;

FIG. 2 shows a schematic view of a system according to a second embodiment of the invention; and

FIG. 3 further illustrates the second embodiment of the invention.

### DETAILED DESCRIPTION OF PREFERRED EMBODIMENTS

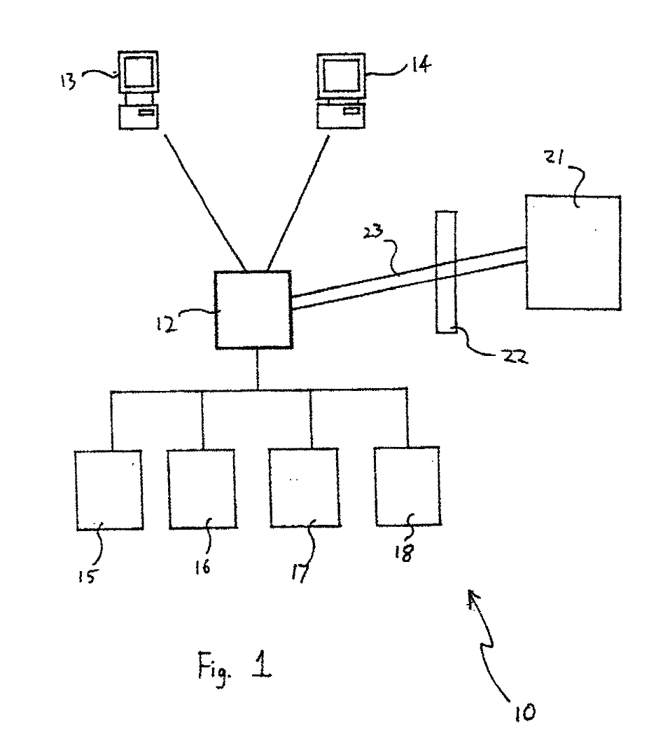

Shown schematically in FIG. 1 is an online election system 10. The focal point of the system 10 is a host server 12. The host server 12 runs an internet based server application that can be accessed through web-enabled user browsers 13, 14.

The host server 12 performs routine server functions and is the interface into multiple data sources 15, 16, 17, 18 storing the information served out to the end user. The data sources include a general database 15, a registered voter database 16, an electoral database 17 and a registered vote database 18, the function of each which will be described individually below. The databases may be of any proprietary relational database type such as the Oracle®, Microsoft SQL™0 or Sybase® databases.

The general database 15 stores information generic to the on-line election system, such as how to vote information, election rules, voter-registration forms, candidate information etc. The information stored in this database is of low security requirements and can be easily maintained and updated without disruption to the other databases.

The registered voter database 16 stores details of registered voters in a defined scheme The schema includes fields for a voter's unique identifier, name; contact details including address and electronic mail address; Personal Identification Number (PIN), password or pass phrase; and vote status. The vote status field is used to indicate whether the voter has submitted a valid vote for a particular election and may consist of a simple value eg. 0 indicating a voter hasn't voted, 1 indicating that they have. Of course the schema may include other fields, for example containing additional security or verification information. The exact nature of the schema will depend on the type of election being conducted. For wide scale government elections for example, the address fields are important for identifying the electorate that the registered voter belongs to. For smaller scale elections, eg within an organisation, the address fields may not be important and instead the schema may store for example a voter's membership number for the organisation, which may also form the unique identifier for that voter.

The electoral database 17 stores information specific to the election being conducted such as ballot forms containing a list of candidates. Where there is more than one list of candidates for an election, the electoral database may also contain look-up tables for determining the appropriate list of candidates to be provided to a voter. If the appropriate candidate list is dependant upon one or more details of a registered voter, the look-up tables may equate fields of voter records with candidate lists.

For example, the list of candidates required by a registered voter may be dependent on the electorate of the voter. The voter's electorate may be stored in a field in their respective record in the registered voter database 16, in which case the electoral database 17 will contain a look-up table matching an electorate with a list of candidates for that electorate.

Alternatively, the electorate may be determined from the address field of a registered voter's record in which case the electoral database 17 will contain two look-up tables, the first matching addresses or postcodes with electorates, the second matching electorates with candidate lists. It is possible that one look-up table matching addresses or postcodes with candidate lists be used, however this latter method is not preferred where the databases are to be reused for subsequent elections, as it requires more intensive maintenance when a list of candidates for an electorate is changed. For a similar reason, it is preferred that a voter's electorate is determined from their address or postcodes rather than being stored dingy in the voter records, as changes to the electorate boundaries are more easily accommodated.

The fourth database shown at 18 in FIG. 1 is a registered vote database which stores and tallies all validly submitted votes. The registered vote database 18 preferably contains divisions to facilitate the accurate tallying and reporting of the vote. For example, the vote database may be divided into electorates and the votes may be stored according to the electorate to which they relate. Each division may then be tallied independently to achieve a result for that electorate. Divisions in the vote database assist the speed at which the vote may be tallied and also reduces the storage requirement of the database because, for example, the electorate to which a vote belongs does not have to be stored for each vote.

To establish the registered voter database 16, the system according to the invention includes a registration system. Prior to an election, a user may access the host server 12 through a user interface 13, 14 to retrieve an electronic registration form from the general database 15. The user provides the requested information such as name, address and other personal details for example drivers license number, credit card number etc. and submits it electronically in a known manner to the host server 12. The information is then retrieved at the host, and a new record is created in the registered voter database for the user based on the details provided. The task of retrieving a user's details and creating a new record may be performed manually by an operator with authorised access to the registered voter database 15, or may be performed automatically through a software application run by the host server. To facilitate automation of the registration process, the host server 12 may be further linked to the databases of other institutions for the purpose of searching those databases and verifying security details provided by a user such as credit card numbers, passport numbers, driver's license numbers and the like.

Once the voter database is established, it can be reused for any number of elections. It will of course be necessary to clear the vote status fields of all voter records Once an election is completed and the host server con s an appropriate software application for performing this task.

After a voter record has been created, and all the details provided by the user have been verified, the user then becomes registered as a voter and is issued with a unique identifier assigned by the host server, and other security information such as a Personal Identification Number (PIN), password or passphrase which may have been chosen by the user when submitting their registration form. The identifier and security details form part of the voter's record in the registered voter database 16.

The unique identifier provides a registered voter with a means of identifying themselves to the host and can be implemented in a variety of ways deeding on the security requirements of the election administrator and the method of registering voters. In a most preferred form, upon registration a voter is issued with a uniquely encoded smart card and personal identification number. Identification to the host during an election then requires a card reader attached to the user browser. At present these are available at some office computers and can be provided at specialised online polling booths, but it is anticipated that smart card readers for facilitating on-line transactions will be a part of standard personal computer hardware in the near future, thus the voter's own personal computer will be suitable.

In a simpler form, the registered voter may be issued with a unique identifier which may simply be a number issued sequentially by the host server to sequentially registered voters, that the voter manually enters at the user interface m order to identify themselves to the host server

When an election is held, all registered voters may submit their vote using the on-line election system of the present invention. To submit their vote, a user first accesses the host serve 12 through a user browser 13, 14 The host server displays a generic election page from the general database I 5 onto the user browser and prompts the user to provide the voter's registration details The voter identifies themselves to the host by providing their unique identification, for example in one of the ways described above

The voter also provides further verification details such as a PIN or password to a level dependent on the security levels of the election system, The registered voter database 16 is then searched to locate a record matching all the details provided by the prospective voter.

If no matching record is found, the user is given the option to re-submit their registered details, return to the title page of the election or exit If the details provided by the user accord with a record in the registered voter database the user is verified as a registered voter and a log-in session with a session identifier is created for that voter. The voter is then advanced to the next stage of the election procedure. At this point the host server retrieves an appropriate list of candidates from the electoral database 17, and causes the list to be displayed at the registered voter's browser. The list of candidates retrieved from the electoral database 17 may be a standard list for all voters or may be determined using suitable look-up tables stored in the electoral database 17. In order to determine the list of candidates appropriate for a registered voter, it may be necessary for the host server 12 to access the registered voter's record and equate specific details of the voter with a list of candidates. For example, the voter's address can be used to retrieve the list of candidates for the electorate that the voter belongs to.

With a list of candidates displayed on the user browser, the registered voter is able to indicate their vote in a known manner analogous to completing a ballot paper, for example by selecting their choice of candidate with an attached mouse device of the browser or by touch pad. Depending on the rules of the election the voter may be able to select their most preferred candidate or select candidates in a preferential order. When a voter is satisfied with their vote, a tool can be selected to submit the vote indicated at the user browser to the host server Once the submit tool is chosen, the vote information indicated by the registered voter is transferred in a known manner using standard protocols from the voter's interface to the host server. To allow the identity of the voter who submitted the vote to be determined by the host server, the vote information may be submitted with the unique identifier of the voter. Alternatively, the voter identity may be determined by the host server from the log-in session identifier.

As a first stage of receiving the vote the host server checks the vote status field of the voter's record to ensure that the voter has not previously submitted a vote for the particular election and checks the vote to ensure it has been submitted in an acceptable form. An acceptable form may be that only one candidate has been indicated or that the candidates have been sequentially numbered to show the preferences of the voter. If a vote is rejected the voter is informed and allowed to re-cast their vote.

Once the form of a vote has been checked and approved the host server informs the voter that their vote has been successfully submitted, and the voter is then free to terminate the log in session The host server then uses either the log in session identifier or the voter identifier if submitted with the vote, to determine the identity of the voter and update the voter's record to change the value in the vote status field from a 0 to a 1 to indicate that the voter has submitted a valid vote. At the same time, the host server 12 removes all specific voter identification from the vote, including the voter's unique identifier and log-in session identifier, and passes the vote to the registered vote database 18. The vote is then stored in the appropriate division of the registered vote database 18 which may be determined from information passes with the vote by the host server or from information integral with the vote itself. For example, the host server may explicitly tag a vote as belonging to a particular electorate, or the electorate may be implicit in the list of candidates associated with the vote.

At the conclusion of the election, the host server 12 runs a software application to tally all votes stored in the vote database and generate reports based on the result. The tallying system may be adapted to tally the votes according to a preferential or “two party preferred” voting system. Where, after at least a portion of the votes have been tallied, it is not possible for a particular candidate to win, the votes of the voters who indicated that candidate are distributed to the other candidates in accordance with the preferences of those voters. The tallying system may farther include a means to assign a weighting to a voter's preferences, as is done in, for example, the Australian Senate Elections. Alternatively the votes may be tallied according to a “first past the post” system wherein the successful candidate is deemed to be the one with the most primary votes out of all candidates. After the vote is tallied a report is generated of the result and made available for viewing on the computer network through the host server.

Once voting in an election has ceased, the election system can be used to determine those registered voter's who voted and those that did not by searching the vote status field of all records in the registered voter database 16. If voting in an election is compulsory, the host serve can automatically generate a list of voters who did not participate, and can further generate notices that a fine is payable and issue these notices to non-participating voter's by electronic mail using the mail address in a voter's record.

The general database 15 preferably includes an on-line fine payment form whereby a fined user can pay their fine using the computer network The voter accesses the payment form through the user browser/host server connection and provides their financial account details, for example their credit card number and expiry date. 1The election system then retrieves these details and, using a secure electronic link 23 to a financial network 21 through a firewall 22, transfers the amount of the fine from the user's account to one or more financial accounts authorised to receive the fine payments. The voter's account information is then deleted from the election system and the voter's record flagged as having paid the fine. The flag may include a receipt that is issued, preferably electronically, to the user. The fine payment system may be implemented using any appropriate c-commerce engine such as the Transact™ engine developed by Open Market Inc. Once all fines have been issued and paid, the host server runs an application to reset the vote status fields of all records to a 0 so that the databases are then ready to be used for further elections.

Preferably it is possible to vary the amount or type of information that a user must provide in order to be registered. In this way the election system cam be adapted to conduct elections for several different organizations by catering to the particular needs of each organisation.

The election system is most suitably implemented using the world wide web. This allows it to be accessed from most places around the word, including a person's home or office or at a polling booth having online facilities, at a relatively cheap cost The election can therefore be conducted at minimum inconvenience to voters. The election system may have a central web site and several mirror sites in order that it can handle the high level of use it could potentially receive during an election. The web site may contain additional links to election related web site such as those for the candidates.

The information stored in the election system, particular the registered voter database may be encrypted so that it can be viewed only by persons having the appropriate security clearance. It is also preferable that the user browser be able to support encryption technology to a level depending Won the security requirements of the particular election being conducted. For a government election, it is preferred tat the communications between the host server and user browser be protected by 128 bit encryption software or better, running on a public/private key exchange system.

The host server may include a proprietary plug-in encryption system stored in the general database 15 that can be downloaded to a user's browser if the security systems on the browse are inadequate,

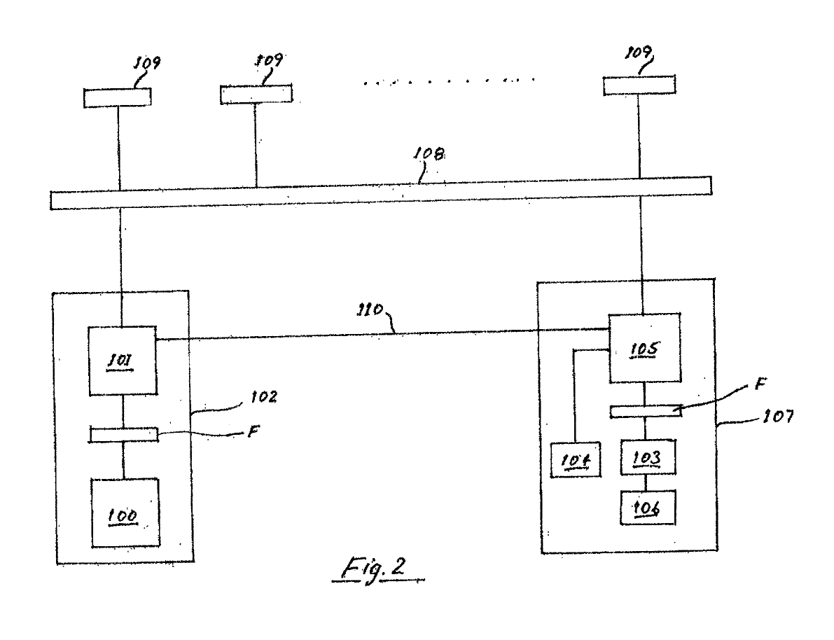

FIG. 2 illustrates an embodiment of the invention in which the tasks of Voting Server and Voter Server are separated, an in relation to which the severity applied to the process of communication in the course of voting is described in more detail.

In this embodiment, in order to provide a more transparently secure electoral process, responsibility for the voter database on the one hand, on the other hand the functions of recording and counting votes are separated.

In the embodiment schematically illustrated in FIG., 2, the voter database 100 is accessed exclusively by a Voter Server 101 (via a firewall F) under the control of suitably authorised individuals identified here as a Voter Management Group (VMG) 102. The ballot database 103 and the elegy or candidate database 104 are accessed by a Voting Server 105. A Counting Server 106 is also provided, which functions to decrypt and count votes. The candidate and ballot databases and their associated servers are under the control of authorised individuals referred to here as the Ballot Management Group (BMG) 107.

As in the previous embodiment, the system which w now be described m detail is envisaged as operating on a global network such as the world wide web, although this is not essential.

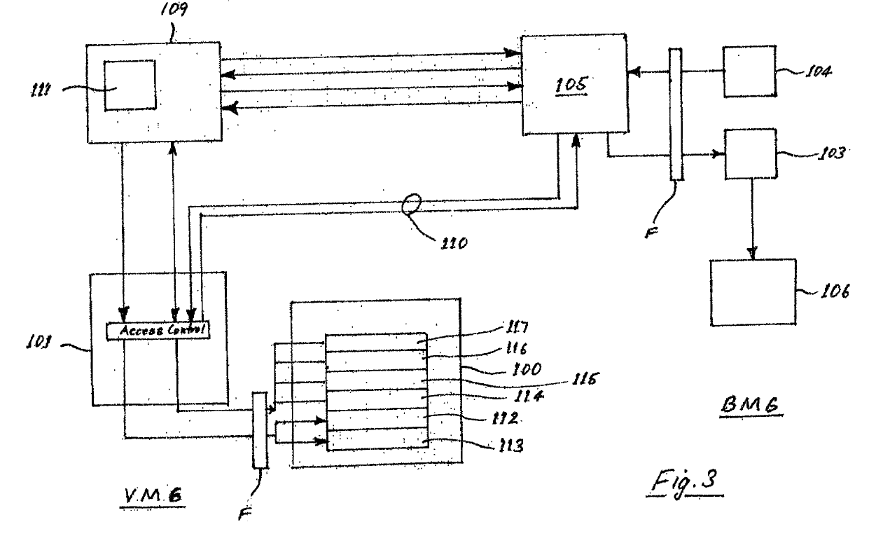

FIG. 3 schematically illustrates the communication relationships between the elements of the system. Voters communicate with the system via secure browsers 109. These browsers communicate wt the servers 101 and 105 using an encryption protocol, preferably the internet protocol SSL. Voting processes within the browsers are carried out by a software component 111, which may take the form of a downloadable component such as a Java applet or Active-X control. This component will provide forms handling software, and may incorporate or invoke the required digital certificate and encryption functions referred to below.

Voter registration may be carried out in any suitable way, for example by using traditional processes or electronic registration as described above, and in registering each voter will choose a password and will receive a unique Digital Identifier (voter ID). The voter database 100 stores the necessary information relating to each registered voter, including hash values corresponding to the voter ID 112 and password 113. As described above, the voter database will also provide a vote status field 114, and may store other information 115, 116 such as geographical or electoral zone information The database may store additional security devices such as a number of challenging questions 117.

The voting process begins with the voter logging on to the voter server with the voter's ID and password. After hashing the ID and password to validate the voter, the voter status is checked. If the voter ID or password is invalid, or the voter status is “voted”, the login will be rejected. Otherwise, the voter server 101 sends to the voter the bashed voter ID, and any other information which is reamed by the voting server 105 for the production of the ballot form for the voter in question.

If desired, a Further check of the voter's identity can be carried out prior to this transmission of data, for example by asking for the voter's answers to challenging questions selected at random from those stored in the voter's record in the voter database.

Upon receiving the hashed ID and other information, the voter confirms it, and activates the forwarding of the information to the voting server 105, for example by clicking on a “continue” button or responding to any other suitable prompt The voting server 105 responds by generating a ballot form using the candidate database 104. The ballot form is transmitted to the voter with a digital certificate.

Where the voting is not for the election of candidates, but rather a vote on issues, for example a referendum, the candidate database 104 will be replaced by a file containing the issues for presentation on the ballot form. It will also be appreciated that an election and a referendum may be conducted simultaneously, with the candidate database, or another file, containing the referendum issues.

After authenticating the digital certificate, the voter completes the ballot form. The resulting vote is encrypted by the software component l 11l, and forwarded with a digital signature to the voting server 105. At the voting server 105 the digital signature is authenticated, and the hashed voter ID separated from the encrypted vote itself, the latter being stored in the ballot database 103 without any voter identity data

By means of a secure private link 110, rather than by the internet, the hashed voter ID and other voter information is sent to the voter server 101 so that the fact tat this voter has voted can be recorded in the voter database 100. The digital signature of the voter server originally attached to the voter information is authenticated by the voter server to ensure that the voter information has not been altered in the course of the internet transactions, and providing the voter status is not “Voted”, changes the status to “Voted” and returns an acknowledgement to the voting server via the secure link 110. If the voter status is “Voted”, indicating that a ballot has been received in respect of that voter since the login referred to above, an “invalid vote” message is returned to the voter server 105.

Upon receipt of either message from the voter server 101, the voting server 105 either commits the ballot database transaction and returns a receipt to the voter, or rolls back the transaction and advises the voter of the reason for rejection.

The encryption processes employed in the system thus far described preferably employ an available public key infrastructure well known in the art and therefore not fiber described herein. Similarly the use of digital signatures wherever necessary is assumed and not always detailed herein.

Secure storage of the ballot information in the ballot database 103 also uses public key cryptography. In this case a Private Key-1, required for a counting or recounting process by the server 106, is itself not stored on any computer, but is rather divided into n (preferably 2 to 4) pats and the, parts separately kept by n members of the Ballot Management Group 107. In order to perform a count or recount, all the parts of the Private Key-1 must be put into the server 106.

In performing a count, the counting server retrieves the encrypted ballot data from the ballot database 103, decrypts the ballots using the Private Key-l, counts the votes and produces the results.

The above embodiment has been described with reference to an election conducted over a wide area network or a global network such as the internet. Such an application is suitable for conducting large scale elections, for example the election of government officials.

If an election is to be held on a smaller scale, for example within an organisation, the online election system may be implemented on a local area network. In this case the host need only run a local server application with the user browsers forming part of the local internet, that is, they are hard wired into the network. I is situation the optional fine payment system will not be able to be employed without the host server running a software application allowing it to link with a wider network, but for snail scale elections, this feature is unlikely to be necessary.

The voting system as outlined above is suitable for electing representatives for governments, councils, businesses, societies, etc., and for the conduct of plebiscites and referenda where issues, rather than candidates for election, are to be decided. The confidentiality of a person's vote is eared because once a person's vote is submitted, it is stripped of any voter identification and the vote is stored in a separate Baked database so that the vote can not be correlated to the voter who submitted it.

An election conducted on-line can save on resources required for ballot papers, candidates information, how-to-vote cards and the like, all of which can be provided via the computer network The on-line election system with appropriate security measures such as those described can also save on human resources because there is no need for people to staff polling booths, tally the vote or act as scrutineers. An added advantage is that many sources of human sources are removed.

An on-line election also provides convenience to the electorate because they do not have to attend a polling booth. This is particularly useful for people such as the disabled and their carers, and people who would otherwise have to travel large distances to attend a polling booth. In addition, the curt postal vote ad absentee systems could be made obsolete because access to the on-line election would merely require a computer with a modem attachment and could occur from almost anywhere worldwide. The system will also facilitate the conducting of plebiscites, for example referenda for constitutional reform, the use of which is presently discouraged by the high cost of the operation

While particular embodiments of this invention have been described, it will be evident to those skilled in the art that the present invention may be embodied in other specific forms without departing from the essential characteristics thereof. The present embodiments and examples are therefore to be considered in all respects as illustrative and not restrictive, the scope of the invention being indicated by the appended claims rather than the foregoing description, and all changes which come within the mining and range of equivalency of the claims are therefore intended to be embraced herein.

I claim:

1. A voting system including a computer network having server means and a plurality of user interfaces, said system further including:
a) a registered voter database accessible by said server means and containing voter identification records for a plurality of registered voters;
b) a voter verification system including means to receive identification information provided by a user at a user interface and means to determine if said user is a registered voter by matching said information provided by said user to a record contained in said registered voter database;
c) means to display ballot information at a user interface;
d) means by which a registered voter can indicate their vote at the user interface;
e) means by which a registered voter can submit their vote from the user interface to the server means;
f) mean for tallying votes submitted by a plurality of registered voters;
g) wherein when a vote is received at the server means
i) all voter identification is removed from the vote,
ii) the vote is passed to the means for tallying and
iii) the registered voter who submitted the vote is flagged as having voted.

2. A system according to claim 1 wherein said means for tallying includes a ballot database that receives and stores votes submitted.

3. A system according to claim 2 further including at least one ballot information file storing ballot information to be displayed at a user interface.

4. A system according to claim 3 in which said ballot information includes at least one list of candidates.

5. A system according to claim 3 in which said server means includes a voter server accessing the registered voter database and a separate voting server accessing the ballot database.

6. A system according to claim 5 in which the voting server also accesses the ballot information file.

7. A system according to claim 1 wherein each voter record includes a field containing a unique identifier.

8. A system according to claim 1 further including a registration system including means by which a user may provide personal details through a user interface to said server means, and means for creating a record in said registered voter database corresponding to said user including said personal details.

9. A system according to claim 8, said registration system further including means to assign a unique identifier to said user and to store said unique identifier in said user's record.

10. A system according to claim 8 wherein said computer network includes at least one electronic link to an external database containing one or more personal details of a user, said registration system including means to search said external database to verify said personal details of a user.

11. A system according to claim 8 flier including means to encrypt communications between said server means and said user interfaces.

12. A system according to claim 4 wherein the list of candidates displayed at a user interface is determined from one or more details contained in a registered voter's record.

13. A system according to claim 12 wherein the one or more details include the registered voter's electorate.

14. A system according to claim 12 wherein the one or more details includes the registered voter's address.

15. A system according to claim 1 wherein when a vote is received at said server means said vote is checked to determine if said vote is in an acceptable form before said vote is passed to said means for tallying.

16. A system according to claim 1 wherein said voter identification records include a vote status field and a voter is flagged as having voted by changing a value stored in said vote status field.

17. A system according to claim 1 fiber including means to determine, after the conclusion of an election, those registered voters that did not submit an acceptable vote and means to notify the registered voters that did not submit a valid vote that a fine is payable.

18. A system according to claim 17 further including a fine payment system including means for a user to provide financial account details of said user to said server means through a user interface and means for said server means to access an electronic financial network to cause a financial amount to be transferred from said user financial account to a financial account authorised to receive fine payments.

19. A system according to claim 18 further including means to issue a receipt in respect of said financial amount to said user by electronic mail.

20. An online election system including a computer network having a host server and a plurality of user interfaces, said system further including:
a) a registered voter database accessible by said host server and containing voter identification records for a plurality of registered voters;
b) a voter verification system including means to receive personal identification information provided by a user at a user interface and means to determine if said user is a registered voter by matching said personal information provided by said user to a record contained in said registered voter database;
c) means to display at a user interface election information including a list of election candidates;
d) means by which a registered voter can indicate their vote at the user interface;
e) means by which a registered voter can submit their vote from the user interface to the host server,
f) means to prevent a registered voter from submitting more than one vote;
g) means for tallying a plurality of votes submitted by a plurality of registered voters;
h) wherein when a vote is received at the host server all voter identification is removed from the vote, the vote is passed to the means for tallying and the registered voter who submitted the vote is flagged as having voted.

21. An online election system according to claim 20 wherein said means for tallying includes a vote database that receives and stores votes submitted by said plurality of voters.

22. An online election system according to claim 21 fiber including at least one further database storing information to be displayed at a user interface, including at least one list of candidates.

23. An online election system according to claim 20 wherein each voter record includes a field containing a unique identifier.

24. An online election system according to claim 20 further including a registration system including means by which a user may provide personal details through a user interface to said host server, and means for creating a record in said registered voter database corresponding to said user including said personal details.

25. An online election system according to claim 24, said registration system further including means to assign a unique identifier to said user and to store said unique identifier in said user's record.

26. An online election system according to claim 24 wherein said computer network includes at least one electronic link to an external database containing one or more personal details of a user, said registration system including means to search said external database to verify said personal details of a user.

27. An online election system according to clam 20 further including means to encrypt communications between said host server and said user interfaces.

28. An online election system according to claim 20 wherein the list of candidates displayed at a user interface is determined from one or more details contained in a registered voter's record.

29. An online election system according to claim 28 wherein the one or more details include the registered voter's electorate.

30. An online election system according to claim 28 wherein the one or more details includes the registered voter's address.

31. An online election system according to claim 20 wherein when a vote is received at said host server said vote is checked to determine if said vote is in an acceptable form before said vote is passed to said means for tallying.

32. An online election system according to claim 20 wherein said voter identification records include a vote status field and a voter is flagged as having voted by changing a value stored in said vote status field.

33. An online election system according to claim 20 further including means to determine, after the conclusion of an election, those registered voters that did not submit an acceptable vote and means to notify the registered votes that did not submit a valid vote that a fine is payable.

34. An online election system according to claim 33 flier including a fine payment system including means for a user to provide financial account details of said user to said host server through a user interface and means for said host server to access an electronic financial network to cause a financial amount to be transferred from said user financial account to a financial account authorised to receive fine payments.

35. An online election system according to claim 34 further including means to issue a receipt in respect of said financial amount to said user by electronic mail.
